(19) United States
(12) Patent Application Publication
(10) Pub. No.: US 2025/0165116 A1
(43) Pub. Date: May 22, 2025

(54) COMPUTER, OPERATION METHOD, AND NON-TRANSITORY COMPUTER-READABLE STORAGE MEDIUM STORING OPERATION PROGRAM

(71) Applicant: SEIKO EPSON CORPORATION, Tokyo (JP)

(72) Inventor: Ikuo MASUJIMA, Asahi-mura (JP)

(21) Appl. No.: 18/947,014

(22) Filed: Nov. 14, 2024

(30) Foreign Application Priority Data
Nov. 16, 2023 (JP) 2023-194843

(51) Int. Cl. G06F 3/04812; G06F 3/04842; G06F 3/04883

(52) U.S. Cl. CPC G06F 3/04812; G06F 3/04842; G06F 3/04883

(57) ABSTRACT

There is configured a computer including a touch panel display configured to display a plurality of objects and a cursor configured to follow a finger, and an execution unit configured to execute processing corresponding to the object pointed by the cursor, wherein a relative position of the cursor with reference to the finger is changed so that the cursor is located ahead in a moving direction of the finger.

The present application is based on, and claims priority from JP Application Serial Number 2023-194843, filed Nov. 16, 2023, the disclosure of which is hereby incorporated by reference herein in its entirety.

### BACKGROUND

### 1. Technical Field

The present disclosure relates to a computer, an operation method, and non-transitory computer-readable storage medium storing an operation program.

### 2. Related Art

As related art, various methods have been proposed in order to improve operability of a touch operation. JP-A-2002-123367 describes that a cursor is displayed at a position a predetermined distance away from a touch position, and the cursor is positioned on an icon by operating the cursor to perform a touch operation. JP-A-2002-287904 describes that a touch panel unit is made larger than a display unit to thereby make it possible to point corners of the display unit. JP-A-2003-186620 describes that when a touch position reaches a screen end, a display position of a button representing the touch position is changed to an inside of the screen, and a touch state of the button is continued until the next touch operation. JP-A-2014-219726 describes that a display position of a cursor with respect to a touch position (a relative position with reference to the touch position) is changed by touching with two fingers.

JP-A-2002-123367, JP-A-2002-287904, JP-A-2003-186620, and JP-A-2014-219726 are examples of the related art.

A configuration that makes fine operations achievable when performing the operations with fingers has been a demanded.

### SUMMARY

A computer for solving the problem described above includes a touch panel display configured to display a plurality of objects and a cursor configured to follow a finger, and an execution unit configured to execute processing corresponding to the object pointed by the cursor, wherein a relative position of the cursor with reference to the finger is changed so that the cursor is located ahead in a moving direction of the finger.

An operation method for solving the problem described above includes detecting a position of a finger of a user, displaying a plurality of objects and a cursor corresponding to both the position of the finger and a moving direction of the finger, and executing processing corresponding to the object pointed by the cursor.

In a non-transitory computer-readable storage medium storing an operation program for solving the problem described above, the operation program makes a computer execute processing including detecting a position of a finger of a user, displaying a plurality of objects and a cursor corresponding to both the position of the finger and a moving direction of the finger, and executing processing corresponding to the object pointed by the cursor.

### BRIEF DESCRIPTION OF THE DRAWINGS

FIG. 1 is a block diagram of a computer.

FIG. 2 is a diagram illustrating a motion of a finger and a cursor position.

FIG. 3 is a diagram illustrating trajectories of a touch position and a cursor position.

FIG. 4 is a diagram illustrating a motion of a finger and a cursor position.

FIG. 5 is a flowchart of cursor display processing.

FIG. 6 is a diagram illustrating a motion of a finger and a cursor position.

### DESCRIPTION OF EMBODIMENTS

Here, an embodiment of the present disclosure will be described in the following order.
(1) Configuration of Computer:
(2) Cursor Display Processing:
(3) Other Embodiments:

### (1) Configuration of Computer

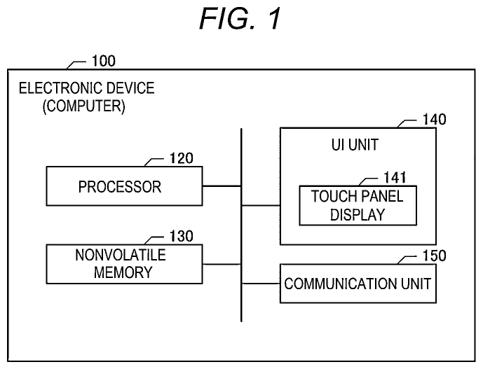

FIG. 1 is a block diagram illustrating a configuration of an electronic device 100 as a computer according to the embodiment of the present disclosure. The computer according to the present embodiment is an electronic device including a touch panel display, and is assumed to be, for example, a tablet or a smartphone.

The electronic device 100 includes a processor 120, a nonvolatile memory 130, a UI unit 140, and a communication unit 150. The processor 120 includes a CPU, a ROM, a RAM, and so on not shown, and is capable of executing various programs recorded on the nonvolatile memory 130 to control each part of the electronic device 100. Note that the processor 120 may be formed of a single chip or may also be formed of a plurality of chips. Further, for example, an ASIC may be adopted instead of the CPU, or a configuration in which the CPU and the ASIC collaborate with each other may also be adopted.

The UI unit 140 includes a touch panel display 141. The touch panel display 141 includes a display that displays any images and a touch panel that overlaps the display, and detects contact with a finger to acquire a coordinate of the contact position. Note that the UI unit 140 includes other input units such as a power button and a volume button, a microphone, and a speaker. The processor 120 can acquire input contents corresponding to the operations to the touch panel display 141 and other input units of the UI unit 140.

The communication unit 150 includes a communication interface for communicating with an external device with various wired or wireless communication protocols. The electronic device 100 is capable of communicating with other devices via that communication unit 150. Note that a keyboard, a mouse, a touch panel display, and so on may be coupled via the communication unit 150, and the processor 120 may input and output various types of information via these devices.

A plurality of objects such as icons is displayed on the touch panel display 141. When the user inputs an instruction with a touch operation on the touch panel display 141, in the present embodiment, operations in two types of methods, namely a cursor operation mode and a touch operation mode, are available in the present embodiment. The touch operation mode is a mode in which a user can make the processor 120 execute processing corresponding to an object as an operation target by touching a position at which that object is displayed. The cursor operation mode is a mode in which the user can make the processor 120 execute processing corresponding to an object pointed by a cursor, that is displayed at a position different from the touch position and follows the movement of the touch position, by superimposing the cursor on the object as the operation target. The details of the cursor operation mode will be described later. The user may be capable of switching between the cursor operation mode and the touch operation mode with a predetermined operation. For example, the switching from the touch operation mode to the cursor operation mode may be started from a touch on a specific region of the touch panel display 141. In this case, the touch operation mode may be restored in response to elapse of a predetermined time from the release of the finger having touched or to a detection of the touch on a region other than the specific region.

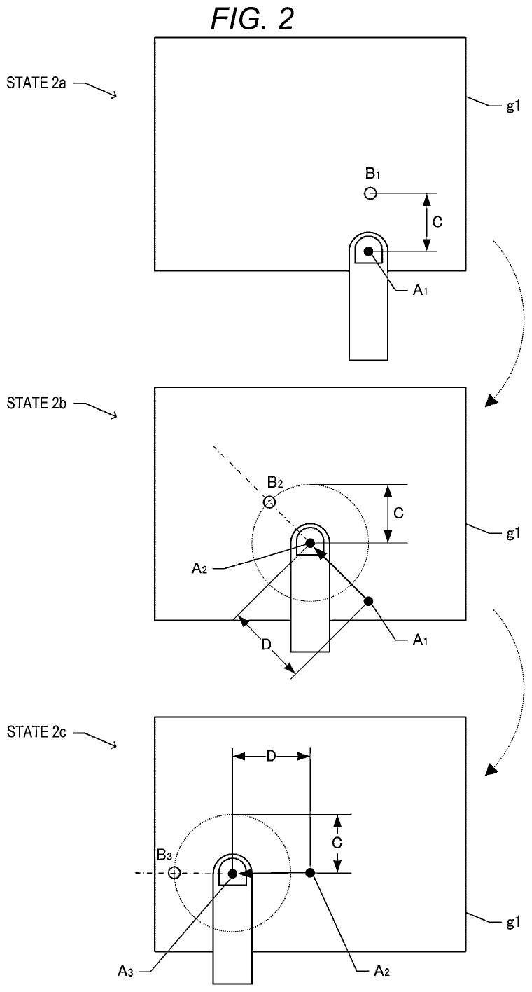

FIG. 2 is a schematic diagram illustrating the motion of the finger and the display position of the cursor in the cursor operation mode. In FIG. 2, an area g1 represents an area in which a touch is detected, and a range in which the cursor can move. In the cursor operation mode, when the user touches any position in the area g1 of the touch panel display 141 with a finger, the processor 120 displays the cursor at a position B₁ at a distance C from a touch position A₁ as represented by a state 2a in FIG. 2. A relative angle of the cursor position with respect to the touch position at the start of the touch is not particularly limited, but is selected so that the position is at the distance C from the touch position A₁, and is within the area g1 since it is desirable that the cursor is displayed in the area g1 at the start of the touch. When the relative angle is defined as an angle between a line connecting a reference point and the cursor position and a reference line extending from the reference point upward in a vertical direction of the screen (the clockwise direction is defined as positive and the counterclockwise direction is defined as negative), this example shows that the cursor is displayed at the position B₁ at the distance C and a relative angle of 0° from the touch position A₁. When the user moves the finger while touching the touch panel display 141, the cursor follows the motion of the finger.

Specifically, the processor 120 changes the relative position of the cursor with reference to the finger such that the cursor is located ahead in the moving direction of the finger. More specifically, the processor 120 displays the cursor at an intersection of a line extending in the moving direction of the finger and a circle centered on the touch position by the finger. The processor 120 provides a threshold value D of a moving distance (linear distance) of the finger for moving the cursor. The processor 120 updates the cursor position when the linear distance between a position Aₙ of the finger before the movement of the cursor and a position of the finger after the movement in a state of keeping the finger touched becomes equal to or longer than D. That is, the processor 120 displays the cursor at a position at which an extension line of the line extending from Aₙ in a direction toward a position Aₙ₊₁ of the finger when the linear distance becomes equal to or longer than D overlaps a circumference of a circle having a radius C centered on Aₙ₊₁. In this way, it is possible to set, as the cursor position, a position that is located on the extension line of the moving direction of the finger, and that is always located at the distance C from the touch position.

For example, a state 2b in FIG. 2 represents a state in which the finger is moved from the state 2a. As shown in the state 2a and the state 2b, when it is detected that the touch position has moved to A₂ at the distance D from A₁, the processor 120 sets the cursor having been displayed at B₁ to a non-display state, and displays the cursor at an intersection B₂ of a circumference of a circle having the radius C centered on A₂ and an extension line of a line extending from A₁ toward A₂. That is, when the touch position moves from A₁ to A₂ while keeping the finger touched, the cursor moves from B₁ to B₂. A state 2c in FIG. 2 represents a state in which the finger is further moved from the state 2b. When the touch position moves from A₂ to A₃, the cursor moves from B₂ to B₃ and is displayed there. B₃ is an intersection of a circumference with the radius C centered on the touch position A₃ and an extension line in a positive direction of a line extending from A₂ toward A₃.

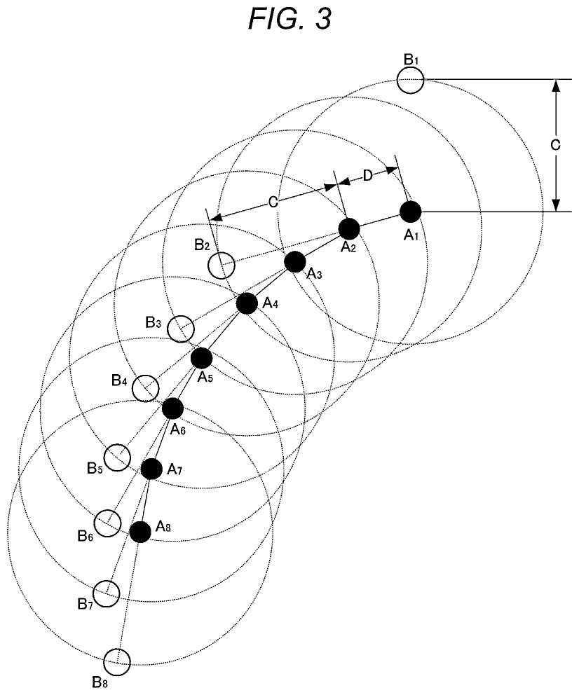

FIG. 3 is a diagram illustrating the touch position thus moving and a trajectory (an example) of the cursor that follows the touch position. Filled circles in the drawing each represent a touch position, and open circles each represent a cursor displayed on the touch panel display 141. The finger smoothly slides through A₁, A₂, A₃, A₄, A₅, A₆, A₇, and A₈. In response to the start of the finger contact at A₁, the processor 120 displays the cursor at B₁. When the finger slides from A₁ in the order described above, the processor 120 deletes the cursor having been displayed at B₁ to newly display the cursor at B₂ in response to the detection of the fact that the finger has reached the position (A₂) at the distance D from A₁ (the cursor is continuously displayed at B₁ until A₂ is reached). Further, in response to the detection of the fact that the position (A₃) at the distance D from A₂ has been reached, the processor 120 deletes the cursor having been displayed at B₂ to display the cursor at B₃. Thereafter, by performing substantially the same processing, the cursor is displayed by jumping in the order of B₄, B₅, B₆, B₇, and B₈ in response to the finger sliding as described above. In this way, by displaying the cursor at new relative positions by jumping in response to changes in the moving direction of the finger, it is possible to make the user feel that the followability of the cursor is better (the delay time until the cursor reaches Bₙ₊₁ from Bₙ is shorter) compared to when, for example, displaying an animation in which the cursor moves from Bₙ to Bₙ₊₁ in response to the detection of the movement from Aₙ to Aₙ₊₁.

Since the cursor is displayed on the circumference of the circle having the radius C centered on the finger in the state of touching the touch panel display 141, the distance between the finger and the cursor is always constant, but the relative angle of the cursor with reference to the finger changes in accordance with the moving direction of the finger. Since the distance between the finger and the cursor is constant, it is easy for the user to figure out an amount of the movement of the finger necessary to move the cursor to the target position.

The distance C and the distance D described above may be made settable. It is possible to adopt a configuration in which change to a value desired by the user can be achieved by a setting change by the user. For example, when the display screen is large, by setting the distance C to be longer than when the display screen is small, it becomes easy to perform the operation up to a distant position on the screen without largely moving the finger. Alternatively, even with such a small screen as in smartphones, it is possible to set C so that operations are easily performed up to an upper portion of the screen although only, for example, a lower portion of the screen is touched when, for example, the operations are performed with a thumb of one hand. Further, the smaller the value set as the distance D, the more sensitively the motion of the finger is detected to make the cursor follow the motion of the finger, but it may also be detected that the finger is unintentionally and slightly moved by the user, and thus, the cursor may frequently move by jumping. On the other hand, the larger the value set as the distance D, the coarser and the more intermittent the movement of the cursor becomes. Since D can be adjusted by setting, it is possible to provide an opportunity to obtain an operational feeling suitable for the user.

In such a manner as described above, the user can move the cursor to a desired position. The user can make the processing corresponding to the object pointed by the cursor be executed by making the cursor overlap the position where the object as the operation target is displayed, and then performing a predetermined operation. In this case, the processor 120 functions as an execution unit. The predetermined operation may vary depending on the type of the touch panel display, the operating system, and the application. For example, it is possible to adopt a configuration in which the processing corresponding to the object as the operation target is performed when the finger continuously stops for a predetermined time in a state where the cursor is superimposed on the object, or a configuration in which the processing corresponding to the object is performed when it is detected that the finger is released from the state where the cursor is superimposed on the object. Alternatively, it is also possible to adopt a configuration in which the processing corresponding to the object is performed when a single tap or a double tap is detected in a state where the cursor is superimposed on the object. Further, it is also possible to adopt a configuration in which the processing corresponding to the object is performed when the finger is strongly pressed in a state where the cursor is superimposed on the object as the operation target when the pressing force against the touch panel can be detected. What kind of processing is performed as the processing corresponding to the object may vary depending on the type of the touch panel display, the operating system, and the application. There may be a plurality of predetermined operations, and different processing may be performed for each operation.

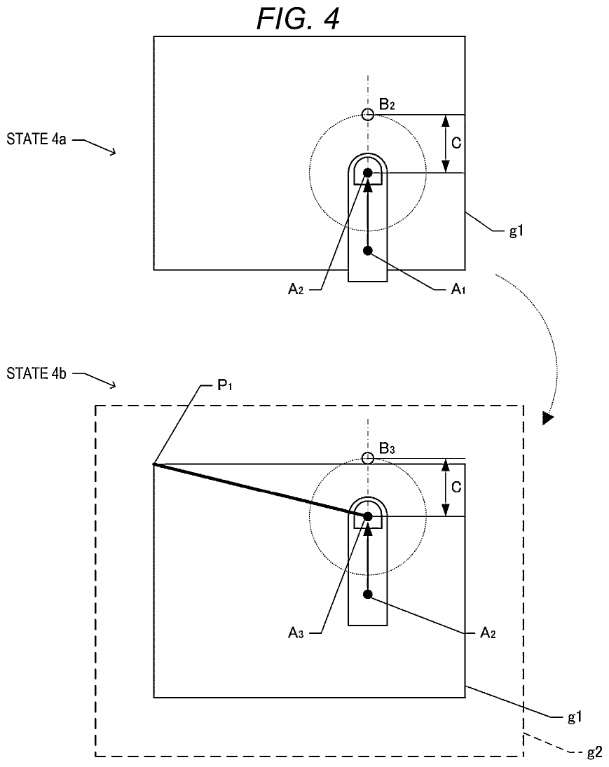

Note that when the cursor reaches an end portion of the moving range of the cursor, the processor 120 sets the cursor in the non-display state. The moving range of the cursor is a range in which the cursor can be displayed, and in the case of FIG. 4, the area g1 corresponds to the moving range of the cursor. The processor 120 provides an area g2 corresponding to a virtual screen outside the area g1, which is the moving range of the cursor, and assumes that the cursor moves to the area g2 outside the area g1 by calculating the cursor position in substantially the same manner as described above even when the cursor reaches the end portion of the area g1. Since the area g2 outside the area g1 is an area that is not displayed on the touch panel display 141, the cursor is set to the non-display state. For example, by the touch position moving from a state 4a in FIG. 4 to an upper portion of the sheet, the cursor moves to the outside of the area g1 and is set to the non-display state as shown in a state 4b. When the cursor is set in the non-display state when the cursor reaches the end portion of the moving range of the cursor as described above, the relationship between the movement of the finger until the cursor reaches the end portion and the position of the cursor is not contradictory, and therefore, it is possible to prevent the user from having an uncomfortable feeling.

Even when the cursor is set to the non-display state due to the movement to the outside of the area g1, the user can move the cursor to the target position in the area g1 by moving the finger toward the target position in the area g1. For example, when it is desired to move the cursor from the state 4b in FIG. 4 to an upper left end portion P₁, the cursor is displayed on a straight line P₁A₃ by sliding the finger in a direction toward the upper left end portion P₁ from the state of touching A₃, and by continuously sliding the finger on the straight line P₁A₃, the cursor reaches the upper left end portion P₁ before the finger reaches the upper left end portion P₁ of the area g1, and therefore, it is possible to make the cursor superimposed on the upper left end portion P₁. Even when any position in the area g1 is set as the target position, the user can make the cursor superimposed on the target position by touching a position at a distance from the target position and then moving the finger toward the target position.

Note that when supposedly adopting a configuration in which the relative position of the cursor with reference to the touch position of the finger is fixed, there occurs an area to which the cursor cannot be moved in the area g1. Further, when supposedly adopting a configuration in which the relative position of the cursor with reference to the touch position of the finger is changed with an operation of two fingers or the like, the cursor can be moved to any positions in the area g1, but it takes a trouble of changing the relative position with the operation of two fingers. According to the present embodiment, the processor 120 can display the cursor at a position that is located on the extension line in the sliding direction of the finger and is at a predetermined distance from the touch position of the finger. Since the relative position of the cursor with reference to the finger can be changed in accordance with the moving direction of the finger while following the movement of the finger, the cursor can be easily moved to a desired position without performing a special operation for changing the relative position. Further, since the cursor displayed at a position different from the touch position of the finger can be superimposed on the object to execute the processing corresponding to that object, it is possible to perform a fine operation compared to the touch operation mode.

### (2) Cursor Display Processing

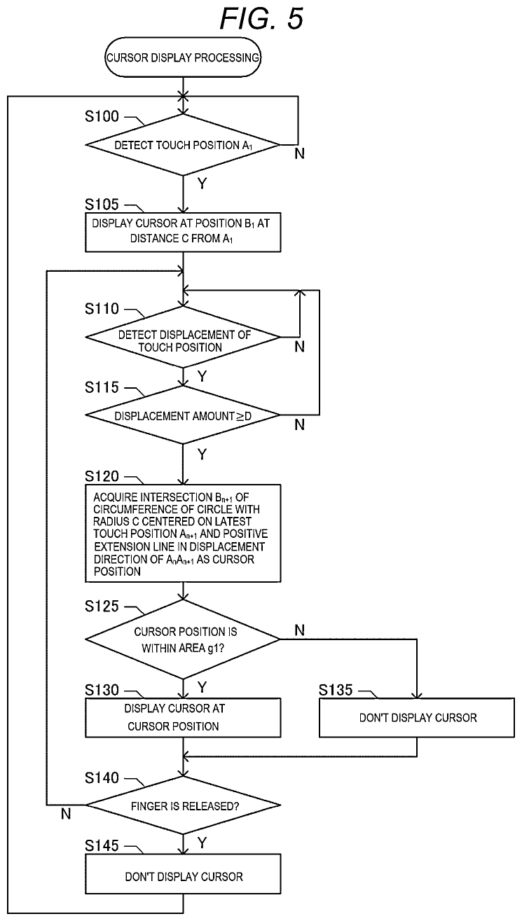

The processor 120 can make the computer realize the cursor display function described above by executing the operation program recorded on the nonvolatile memory 130. FIG. 5 is a flowchart showing cursor display processing. The cursor display processing is started when the transition to the cursor operation mode is made. When the cursor display processing is started, the processor 120 waits (step S100) until a touch is detected, and then displays (step S105) the cursor at the position B₁ a predetermined distance C away from the touch position A₁ thus detected when the touch is detected.

Subsequently, the processor 120 waits (step S110) until the displacement of the touch position is detected. That is, it is determined whether the latest touch position has changed from the touch position serving as the reference of the position of the cursor currently displayed. When it is determined in step S110 that the change in the touch position has been detected, the processor 120 determines (step S115) whether an amount of the displacement is equal to or greater than D. The amount of the displacement is a linear distance from a touch position serving as a reference of the position of the cursor currently displayed to the latest touch position. It is assumed that the touch position serving as the reference of the position of the cursor currently displayed is referred to as Aₙ, and a latest touch position at a distance equal to or longer than D from Aₙ is referred to as Aₙ₊₁.

When it is not determined in step S115 that the amount of the displacement is equal to or greater than D, the processor 120 returns to step S110. When it is determined in step S115 that the amount of displacement is equal to or greater than D, the processor 120 acquires (step S120), as the cursor position, an intersection Bₙ₊₁ between the circumference of the circle with the radius C centered on the latest touch position Aₙ₊₁ and a positive extension line based on the position ₙ₊₁ in the direction of the displacement of Aₙ Aₙ₊₁. Subsequently, the processor 120 determines (step S125) whether the cursor position is within the area g1, displays (step S130) the cursor at the cursor position when the cursor position is within the area g1, and sets (step S135) the cursor to the non-display state when the cursor position is not within the area g1. That is, the cursor is displayed in the area g1 in step S130, and the cursor is not displayed in the area g1 in step S135.

After executing step S130 or step S135, the processor 120 determines (step S140) whether the finger is released, and then returns to step S110 when it is not determined that the finger is released (when the touch state continues). When it is determined in step S140 that the finger is released, the processor 120 sets (step S145) the cursor to the non-display state and then returns to step S100. As a result, there is provided the state in which the cursor is not displayed in the area g1. Note that as the processing when the touch state is changed to the non-touch state, various aspects may be adopted in accordance with the aspect of the predetermined operation for executing the processing corresponding to the object pointed by the cursor. For example, when adopting a configuration in which the processing corresponding to the object as the operation target is performed when the finger continuously stops for a predetermined time in a state where the cursor is superimposed on the object, or a configuration in which the processing corresponding to the object is performed when it is detected that the finger is released from the state where the cursor is superimposed on the object, it is possible to set the cursor to the non-display state in response to the setting of the non-touch state as represented in step S145.

Further, for example, it is possible to adopt a configuration in which the display aspect of the cursor is changed between a state in which the finger is touched and a state in which the finger is released, and in that case, the processor 120 displays the cursor in the display aspect representing the touch state in step S105 and step S130. Then, when it is determined in step S140 that the finger is released, the aspect of the cursor displayed in the area g1 when the latest cursor position is in the area g1 is changed from the aspect representing that the finger is in the touch state to the aspect representing that the finger is not in the touch state, and the process returns to step S100. Such a configuration in which the display aspect of the cursor is changed between the touch state and the non-touch state may be adopted when adopting a configuration in which when, for example, a single tap or a double tap is detected in the state in which the cursor is superimposed on the object, the processing corresponding to that object is performed.

Alternatively, it is possible to adopt a configuration in which the display aspect of the cursor is not changed between the touch state and the non-touch state, and in that case, when it is determined in step S140 that the finger is released, the processor 120 returns to step S100 while keeping the state in step S130 or step S135.

When a predetermined operation is detected when the cursor is displayed in the processing described above, and the cursor points any object, the processor 120 executes the processing corresponding to that object.

### (3) Other Embodiments

The embodiment described above is an example for implementing the present disclosure, and other various embodiments can be adopted. For example, the present disclosure may be implemented in an operating system of an electronic device, or may be implemented in a specific application.

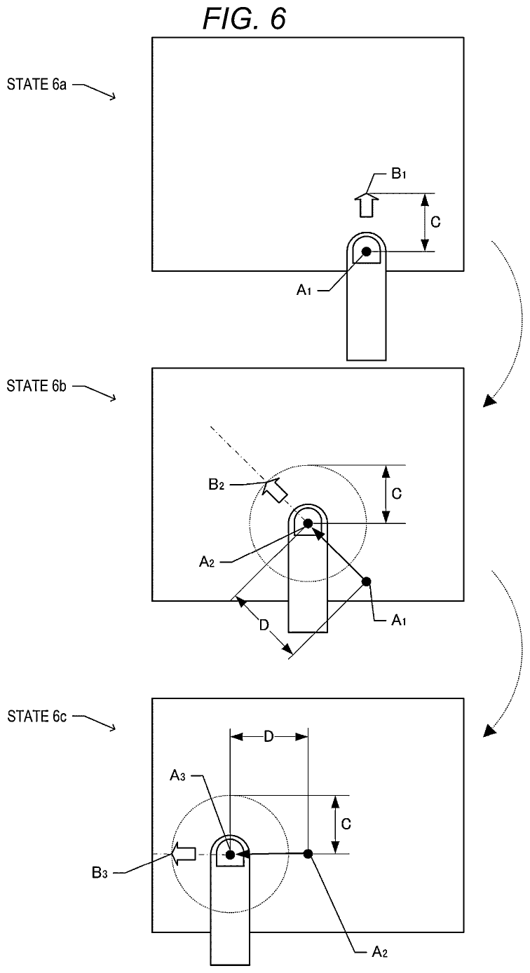

The cursor may have an arrow shape as shown in FIG. 6. In this case, it is possible to adopt a configuration in which the direction of the arrow coincides with the moving direction of the finger. For example, when the touch position moves from A₁ to A₂ as shown in states 6a, 6b in FIG. 6, control of displaying an arrow whose direction coincides with a direction from A₁ to A₂ is performed, and when the touch position moves from A₂ to A₃ as shown in states 6b, 6c, an arrow whose direction coincides with a direction from A₂ to A₃ is displayed. When the user slightly moves the finger, there is a possibility that the direction recognized by the user as the direction in which the user moves the finger may be different from the moving direction detected. In such a case, by matching the direction of the arrow of the cursor with the moving direction of the finger as in this example, it is possible to easily make the user recognize the moving direction detected by the computer with the direction of the arrow.

In the embodiment described above, there is cited the example in which the cursor jumps to a new relative position in response to a change in the moving direction of the finger, but this example is not a limitation. For example, an animation in which the cursor moves to the position of the cursor after the movement may be displayed so that it is easy to understand where the cursor has moved from the display position so far although the followability is poor, or it is possible to adopt a configuration in which a line, an arrow, or the like representing the movement trajectory from the cursor position before the movement to the cursor position after the movement may be displayed for a certain period of time after the movement on the basis that the cursor after the movement is displayed. Since such a trajectory is also displayed for a certain period of time in a state in which the cursor after the movement is displayed, it is possible to prevent the user who successfully figures out the position of the cursor after the movement from feeling as if the followability is deteriorated, and it is possible to make the user who fails to figure out the position of the cursor after the movement easily recognize the display position of the cursor after the movement by tracing the trajectory.

Note that the present disclosure is applicable to various electronic devices in addition to tablet terminals and smartphones. The present disclosure is also applicable to a personal computer, an electronic whiteboard, an operation panel of a multifunction peripheral, and so on. Further, the present disclosure is also applicable as a program or a method executed by a computer. For example, the present disclosure is also realized as a disclosure of an operation method including detecting a position of a finger of a user, displaying a plurality of objects and a cursor corresponding to both the position of the finger and a moving direction of the finger, and executing processing corresponding to the object pointed by the cursor. Such an operation method is not limited to an electronic device including a touch panel display, and can also be used in an electronic device not including the touch panel display. The motion of the finger may be detected as the movement in a two-dimensional plane or may be detected as the movement in a three-dimensional space. The display and the electronic device that detects the motion of the finger may be separate bodies. Further, the display is not necessarily required, and the object and the cursor may be an aspect of being projected on a screen or may be an aspect of being projected in the air. The processing corresponding to the object may be an instruction to an external device other than the electronic device that detects the motion of the finger, and the electronic device that detects the motion of the finger may be configured to transmit an instruction command corresponding to the object to perform predetermined processing on the external device.

Further, the present disclosure is also realized as a disclosure of an operation program that makes a computer detect a position of a finger of a user, display a plurality of objects and a cursor corresponding to both the position of the finger and a moving direction of the finger, and execute processing corresponding to the object pointed by the cursor.

Further, the system, the program, and the method as described above may be implemented as a stand-alone device in some cases, or may be implemented using components provided to a plurality of devices in some cases, and include various aspects. Further, the present disclosure may be modified appropriately such as a device partially formed of software and partially formed of hardware. Moreover, the present disclosure may be realized as a recording medium storing a program that controls the system. Obviously, the recording medium storing the program may be a magnetic recording medium or may be a semiconductor memory, and any recording medium to be developed in the future can be similarly employed.

What is claimed is:

1. A computer comprising:
a touch panel display configured to display a plurality of objects and a cursor configured to follow a finger; and
an execution unit configured to execute processing corresponding to the object pointed by the cursor, wherein
a relative position of the cursor with reference to the finger is changed so that the cursor is located ahead in a moving direction of the finger.

2. The computer according to claim 1, wherein
a distance between the finger and the cursor is constant.

3. The computer according to claim 2, wherein
when the cursor reaches an end portion of a moving range of the cursor, the cursor is not displayed.

4. The computer according to claim 2, wherein
the cursor is displayed at an intersection of a line extending in the moving direction of the finger and a circle centered on a touch position with the finger.

5. The computer according to claim 2, wherein
the cursor jumps to a new relative position of the cursor with reference to the finger in response to a change in the moving direction of the finger.

6. The computer according to claim 1, wherein
the cursor has a shape of an arrow, and a direction of the arrow coincides with the moving direction of the finger.

7. An operation method comprising:
detecting a position of a finger of a user;
displaying a plurality of objects and a cursor corresponding to both the position of the finger and a moving direction of the finger; and
executing processing corresponding to the object pointed by the cursor.

8. A non-transitory computer-readable storage medium storing an operation program, the operation program making a computer execute processing comprising:
detecting a position of a finger of a user;
displaying a plurality of objects and a cursor corresponding to both the position of the finger and a moving direction of the finger; and
executing processing corresponding to the object pointed by the cursor.
